(19) United States
(12) Patent Application Publication
(10) Pub. No.: US 2017/0017571 A1
(43) Pub. Date: Jan. 19, 2017

(54) METHOD AND APPARATUS FORI N-LINE DEDUPLICATION IN STORAGE DEVICES

(71) Applicant: Samsung Electronics Co., Ltd., Gyeonggi-do (KR)

(72) Inventors: Changho CHOI, San Jose, CA (US); Derrick TSENG, Union City, CA (US); Siamack HAGHIGHI, Sunnyvale, CA (US)

(21) Appl. No.: 14/959,298

(22) Filed: Dec. 4, 2015

Related U.S. Application Data
(60) Provisional application No. 62/194,044, filed on Jul. 17, 2015.

(51) Int. Cl. G06F 12/02; G06F 12/10; G06F 17/30; G06F 3/06

(52) U.S. Cl. CPC G06F 12/0246; G06F 3/0608; G06F 3/0652; G06F 3/0679; G06F 12/1009; G06F 17/30371; G06F 2212/2022; G06F 2212/7201; G06F 2212/1044

(57) ABSTRACT

A storage device for deduplicating data includes a memory that stores machine instructions and a controller coupled to the memory to execute the machine instructions in order to compare a data pattern associated with a write request to stored data. If the data pattern matches the stored data, the controller further executes the machine instructions to increment a counter associated with the data pattern and map a source storage address corresponding to the data pattern to a physical storage address associated with the storage device.

### CROSS-REFERENCE TO RELATED APPLICATIONS

This application claims the benefit of U.S. Provisional Application Ser. No. 62/194,044, filed Jul. 17, 2015, which is incorporated by reference herein.

### TECHNICAL FIELD

This description relates generally to the field of data storage, and more particularly to in-line deduplication in storage systems.

### BACKGROUND

Storage devices are used to store computing information, or data. Examples of storage devices include hard disk drives (HDDs) and solid-state drives (SSDs). Some existing computing systems implement intermediate host processing that attempts to reduce the amount of data before sending the data to a storage device. Examples of such host processing include data compression techniques and data deduplication algorithms.

Data deduplication generally refers to the systematic elimination of duplicate or redundant information. In computing, the host computing system typically performs deduplication by comparing write data to previously stored data. If the write data is new or unique, the write data is sent to the storage device. Otherwise, if the write data is redundant, a reference to the previously stored duplicate data is instead created.

However, host deduplication processing can be intensive with respect to host processor and memory resources, which may have an undesirable effect on host performance. As a result, some existing deduplication methodologies can have drawbacks when used in host computing systems, since host computing performance is of relatively high importance.

### SUMMARY

According to one embodiment of the present invention, a storage device for reducing duplicated data includes a memory that stores machine instructions. The storage device also includes a controller coupled to the memory to execute the machine instructions in order to compare a data pattern associated with a write request to stored data, increment a counter associated with the data pattern based on the data pattern matching the stored data, and map a source storage address corresponding to the data pattern to a physical storage address associated with the storage device.

According to another embodiment of the present invention, a method for reducing duplicated data in a storage includes delimiting a segment of data comprising a data pattern and determining whether the data pattern is included in the storage. The method further includes incrementing a counter associated with the data pattern based on the data pattern being included in the storage, and updating a mapping table associated with a flash translation layer of the storage to associate a source storage address corresponding to the segment with a physical storage address corresponding to a storage unit of the storage that includes the data pattern.

According to yet another embodiment of the present invention, a computer program product for reducing duplicated data in a storage includes a non-transitory, computer-readable storage medium encoded with instructions adapted to be executed by a processor to implement delimiting a segment of data comprising a data pattern. The instructions are further adapted to implement determining whether the data pattern is included in the storage, incrementing a counter associated with the data pattern based on the data pattern being included in the storage, and updating a mapping table associated with a flash translation layer of the storage to associate a source storage address corresponding to the segment with a physical storage address corresponding to a storage unit of the storage that includes the data pattern.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is a block diagram depicting an exemplary deduplication device in accordance with an embodiment of the present invention.

FIG. 2 is a schematic diagram depicting an exemplary solid-state storage device in accordance with an embodiment of the present invention.

FIG. 3 is a flowchart representing an exemplary in-storage deduplication method of reducing redundant stored data in accordance with an embodiment of the present invention.

FIG. 4 is a flowchart representing another exemplary in-storage deduplication method of reducing redundant stored data in accordance with an embodiment of the present invention.

FIG. 5 is a block diagram depicting an exemplary data pattern database implementing a binary hash tree structure in accordance with an embodiment of the present invention.

FIG. 6 is a flowchart representing another exemplary in-storage deduplication method of reducing redundant stored data in accordance with an embodiment of the present invention.

### DETAILED DESCRIPTION

Reference will now be made in detail to embodiments of the present invention, examples of which are illustrated in the accompanying drawings. While the invention will be described in conjunction with the example embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of embodiments of the present invention, numerous specific details are set forth in order to provide a thorough understanding of the concepts of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention.

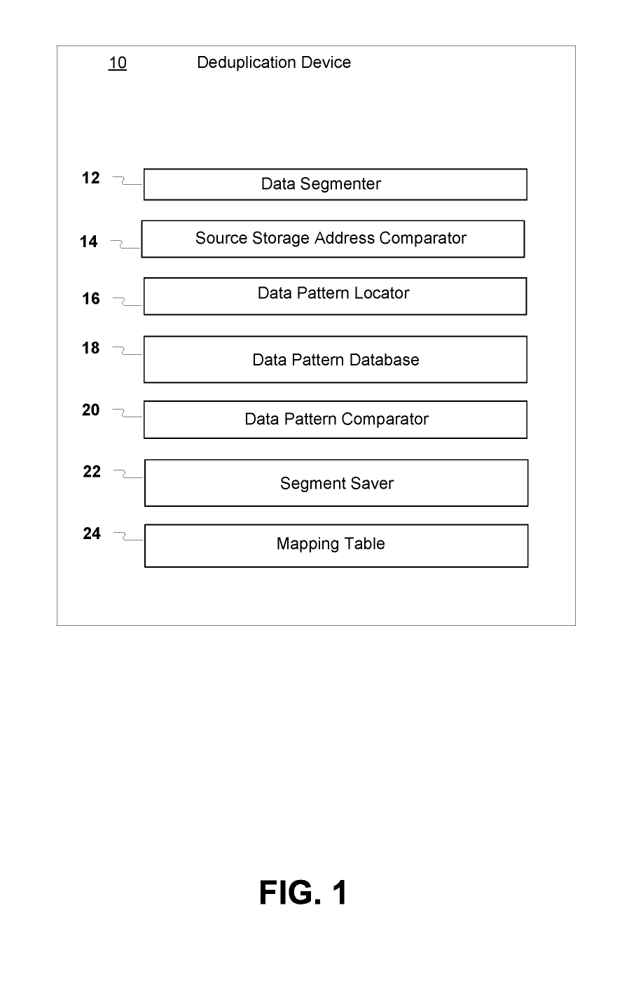

An embodiment of the present invention is shown in FIG. 1, which illustrates an example deduplication device 10 that employs an in-storage deduplication process in order to reduce duplicate or redundant stored data. The deduplication device 10 includes a data segmenter 12, a source storage address comparator 14, a data pattern locator 16, a data pattern database 18, a data pattern comparator 20, a segment saver 22, and a mapping table 24.

By performing in-storage deduplication, the deduplication device 10 can effectively reduce the number of writes performed, for example, to nonvolatile memory (NVM). As a result, device users generally may experience faster write performance, as well as extended lifetime of nonvolatile storage media due to the reduced number of write operations. In comparison to existing deduplication solutions, performance of a corresponding host system processor can be improved, because the bulk of deduplication operations is performed in the deduplication device 10.

The data segmenter 12 divides a data stream into individual segments for deduplication. For example, data corresponding to a write request, or command, may be divided into segments of uniform size equal, for example corresponding to a standard storage unit, such as a physical storage page size, a physical storage block size. For example, in an embodiment, the segment size could be equal to 8 KB, 16 KB, 32 KB, or any other suitable NAND flash memory page size.

In some alternative embodiments, the segment size corresponds to a logical block size associated with logical block addressing (LBA), for example, as defined in the Small Computer System Interface (SCSI) standard promulgated by the American National Standards Institute (ANSI). In an embodiment, logical block addressing implements a linear addressing scheme using a 28-bit value that is correlated with physical blocks of NAND flash memory cells in a solid-state drive (SSD), or with cylinder-head-sector numbers of a hard disk drive (HDD). This approach helps prevent related data from being separated during garbage collection or wear-leveling procedures. In such an embodiment, the number of stored redundant data patterns may be limited to reduce complexity of implementation.

Each segment determined by the data segmenter 12 has an individual data pattern, which may be unique, or new with respect to data currently stored in nonvolatile memory, or may be redundant, that is, the data pattern may duplicate, or match, currently stored data. The source storage address comparator 14 compares the source storage address corresponding to an individual segment, for example, the logical block address (LBA) assigned by the host system, with the source storage addresses of previously written segments currently in storage.

If the source storage address corresponding to the segment matches the source storage address of stored data, the source storage address comparator 14 determines that the corresponding write command overwrites a previously written segment in storage. In this case, the source storage address comparator 14 decrements a reference counter in the data pattern database 18 that corresponds to the previously stored segment. When all source storage addresses correlated with a data pattern have been overwritten or deleted, the source storage address comparator 14 removes the corresponding identifier, physical storage address and reference counter from the data pattern database 18.

In any case, the data pattern locator 16 determines if the data pattern of the individual segment is currently stored in nonvolatile memory. For example, the data pattern locator 16 computes a data pattern identifier based on the data pattern of the individual segment, such as an index, a hash value, or error-correcting code (ECC). The data pattern identifier can be used to access the data pattern database 18, for example, an ordered index or a binary search tree. The data pattern locator 16 searches the data pattern database 18 to determine if the identifier corresponding to the individual segment is found in the data pattern database 18.

The data pattern database 18 includes references to currently stored data patterns. Each identifier may correspond to a unique stored data pattern. Nevertheless, in some embodiments, an identifier may correspond to multiple stored data patterns. In this case, the data pattern database 18 may implement a linked list to relate different stored data patterns with the same identifier.

If the particular identifier that corresponds to the data pattern of the individual segment being searched is found in the data pattern database 18, the data pattern comparator 20 sequentially reads each data pattern stored in nonvolatile memory that corresponds to the particular identifier, and compares each read data pattern to the data pattern of the individual segment being searched. If one of the stored data patterns matches that of the segment being searched, the segment is determined to be redundant. In this case, the data pattern comparator 20 increments the reference counter in the data pattern database 18 that corresponds to the matching data pattern.

On the other hand, if none of the stored data patterns related to the particular identifier matches that of the segment being searched, the data pattern is determined to be new with respect to the data stored in nonvolatile memory. In this case, the segment saver 22 stores the segment in nonvolatile memory. For example, the segment saver 22 adds the segment in a newly allocated storage unit, such as a physical storage page or block, in nonvolatile memory. In addition, the segment saver 22 adds a reference, such as a pointer, to the physical storage address corresponding to the storage unit in which the segment is saved to the linked list, or collision list, corresponding to the particular identifier in the data pattern database 18.

However, if the particular identifier that corresponds to the data pattern of the individual segment being searched is not found in the data pattern database 18, the segment saver 22 stores the segment in a newly allocated storage unit in nonvolatile memory and adds the identifier as a new entry in the data pattern database 18. The segment saver 22 also appends a reference, such as a pointer, to the physical storage address corresponding to the storage unit in which the segment is saved to the new entry in the data pattern database 18.

The mapping table 24 relates source storage addresses, such as logical block addresses (LBAs) assigned by the host system, with corresponding records or nodes in the data pattern database 18. Each time a segment is stored in nonvolatile memory or a reference counter is incremented in the data pattern database 18, the segment saver 22 updates the mapping table 24 to include a pointer correlating the source storage address corresponding to the write command received from the host system with the record or node in the data pattern database 18 that points to the physical storage address where the segment is stored in nonvolatile memory. In an embodiment, the mapping table 24 is associated with a flash translation layer (FTL), and further correlates the source storage addresses with the physical storage addresses where corresponding data is stored in nonvolatile memory.

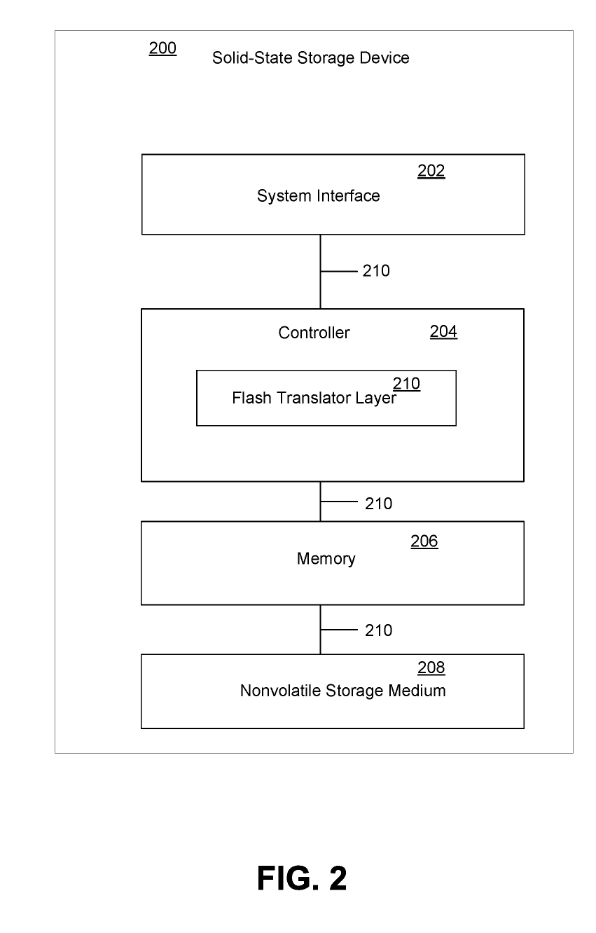

Referring to FIG. 2, an exemplary solid-state storage device 200 that can implement the deduplication device 10 of FIG. 1 includes a system interface 202, a controller 204 a memory 206, and a nonvolatile storage medium 208. The various components of the solid-state storage device 200 are coupled by local data links 210, which in various embodiments incorporates, for example, an address bus, a data bus, a serial bus, a parallel bus, or any combination of these.

The deduplication device 10 may be coupled to a host system or communication network by way of the system interface 202, which in various embodiments incorporates, for example, a storage bus interface, a network interface, a wireless communication interface, an optical interface, or the like, along with any associated transmission protocols, as may be desired or required by the design.

The memory 206 includes any digital memory suitable for temporarily or permanently holding computer instructions and data, such as a random access memory (RAM), a read-only memory (ROM), or the like. The controller 204 includes a processing device capable of executing computer instructions. Programming code, such as source code, object code or executable code, stored as software or firmware on a computer-readable medium, such as the nonvolatile storage medium 208, can be loaded into the memory 206 and executed by the controller 204 in order to perform the functions of the deduplication device 10.

The nonvolatile storage medium 208 includes nonvolatile digital memory cells for storing digital computer data. For example, in various embodiments, the solid-state storage device 200 includes a solid-state drive (SSD) and the nonvolatile storage medium 208 includes single-level cell (SLC) NAND flash memory cells, multilevel cell (MLC) NAND flash memory cells, triple-level cell (TLC) NAND flash memory cells, or any other suitable NAND flash memory cells.

The controller 204 further includes a Flash Translation Layer (FTL) 212, which acts as an interface between the host system addressing scheme and the solid-state storage device addressing, for example, mapping Logical Block Addresses (LBA) from the host system to Physical Block Addresses (PBA) in the nonvolatile storage medium 208. In alternative embodiments, the FTL may be stored as machine instructions in the memory 206, in the nonvolatile storage medium 208, or partially stored in each the memory 206 and in the nonvolatile storage medium 208, and the FTL may be executed by the controller 204.

In some embodiments, the deduplication granularity can be determined in accordance with the flash translation layer (FTL) algorithm used by the solid-state storage device 200. For example, page-level deduplication can be advantageously implemented in conjunction with an FTL utilizing page-level mapping. Similarly, block-level deduplication can be advantageously implemented in conjunction with an FTL utilizing block-level mapping.

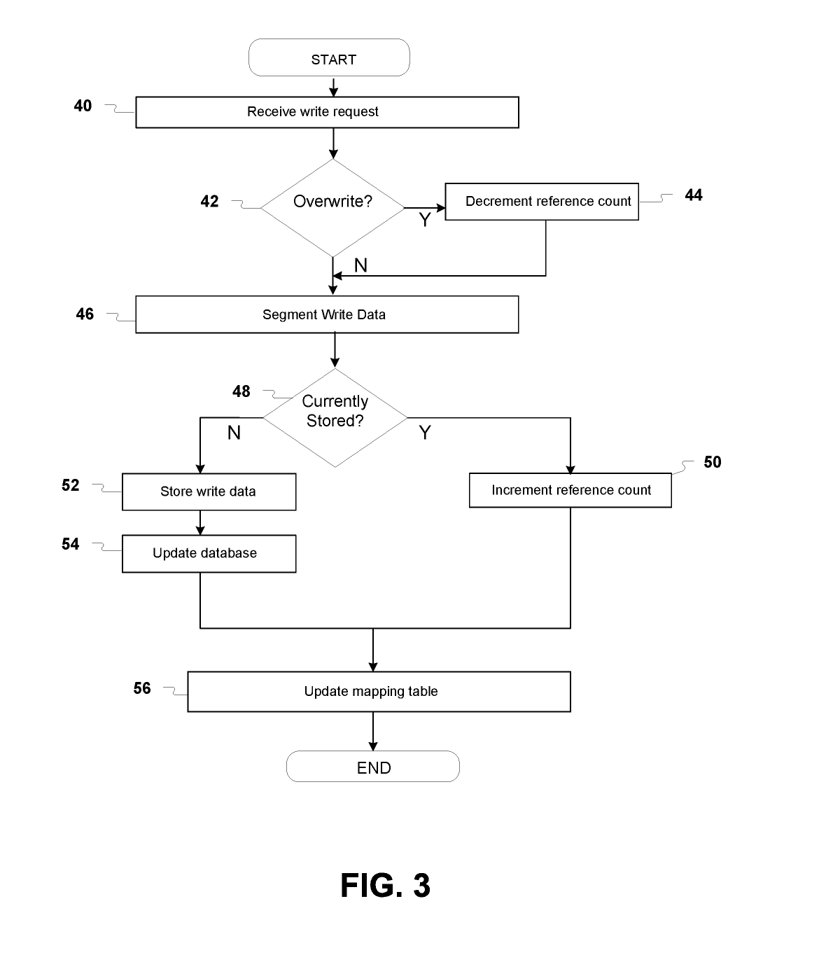

Referring now to FIG. 3, an example process flow is illustrated that may be performed, for example, by the deduplication device 10 of FIG. 1 to implement an embodiment of the in-storage deduplication process described in this disclosure in order to reduce duplicate or redundant stored data. The process begins at block 40, where a write request, or command, is received from a host system with corresponding write data. In block 42, a determination is made as to whether or not the received write request will overwrite a previously written source storage address, such as a logical block address (LBA), that currently is saved in storage. If so, the reference count(s) corresponding to the stored data pattern is decremented in the data pattern database, in block 44.

In block 46, the write data corresponding to the write request optionally may be segmented, or divided into segments, for deduplication. For example, in an embodiment, the write data is divided into segments equal in size to the storage page size. In an embodiment, the segmentation is performed by the data segmenter 12 of FIG. 1, as explained above. However, if the amount of received write data corresponds to the deduplication granularity, segmentation may not be required.

A further determination is made, in block 48, regarding whether or not the write data pattern is currently saved in the storage. In an embodiment, this determination is made by the data pattern locator 16 of FIG. 1, as explained above. If so, the write data is redundant and need not be stored in duplicate. Thus, if the write data pattern is found in the storage, the reference count corresponding to the stored data pattern is incremented in the data pattern database, in block 50. Otherwise, if the write data pattern is not found in the storage, the write data is saved in the storage, in block 52. In this case, the write data pattern is added to the data pattern database, in block 54, and the corresponding reference count is set to one.

In block 56, the storage mapping table is updated to correlate the source storage address with the data pattern database record or node regarding the corresponding data pattern. For example, the flash translation layer (FTL) mapping table may be modified to point to the corresponding node in the data pattern database.

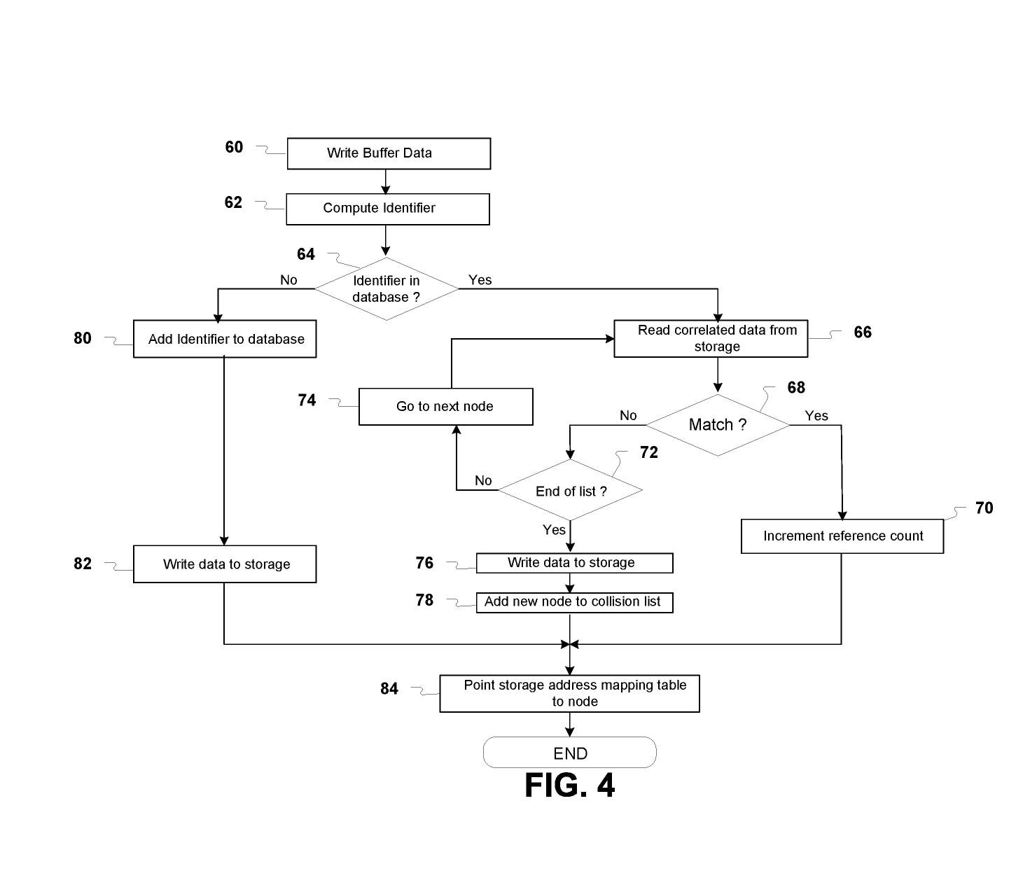

Referring now to FIG. 4, another example process flow is illustrated that may be performed, for example, by the deduplication device 10 of FIG. 1 to implement an embodiment of the in-storage deduplication process described in this disclosure in order to reduce duplicate or redundant stored data. The process begins at block 60, where a segment of write data of size equal to a storage unit, such as a standard physical page or block of a NAND flash solid-state drive, is received in a write buffer.

In block 62, an identifier corresponding to the data pattern of the write data, such as a hash value, is computed. A determination is made, in block 64, regarding whether or not the computed identifier currently is found in the data pattern database, for example, a sorted binary hash tree. In an embodiment, the identifier is computed and this determination is made by the data pattern locator 16 of FIG. 1, as explained above. If the identifier is found in the data pattern database, the data pattern corresponding to a node in the linked list correlated with the identifier is read from the correlated storage unit located at the physical storage address indicated by the node, in block 66. For example, in an embodiment, each node of the linked list points to a physical page address in a NAND flash solid-state drive, and data is read from the particular page indicated by the node.

In block 68, a further determination is made regarding whether or not the data read at block 66 matches the write data received at block 60. In an embodiment, this determination is made by the data pattern comparator 20 of FIG. 1, as explained above. If the two data patterns are the same, the reference count corresponding to the node is incremented in block 70. Otherwise, if the two data patterns at block 68 are not the same, a determination is made as to whether or not there are any additional nodes in the linked list correlated with the identifier, in block 72. If there are any additional nodes in the linked list, the process moves to the next node, in block 74, and continues at block 66.

If the end of the linked list correlated with the identifier has been reached at block 72, then no match was found, and the segment of write data is written to the storage, in block 76. For example, in an embodiment, the segment of write data is stored in a newly allocated storage unit, such as a page of a NAND flash solid-state drive. In block 78, a new node is added to the linked list, or collision list, including the physical storage address where the write data is stored.

On the other hand, if the identifier is not found in the data pattern database at block 64, a new entry including the computed identifier is added to the data pattern database, in block 80, and the segment of write data is written to the storage, in block 82.

In any case, in block 84, the storage mapping table that correlates source storage addresses with physical storage addresses is updated to point to the corresponding node in the data pattern database. For example, in an embodiment, the logical block address (LBA)-to-physical page number (PPN) mapping table may be modified to point to the corresponding node in the data pattern database.

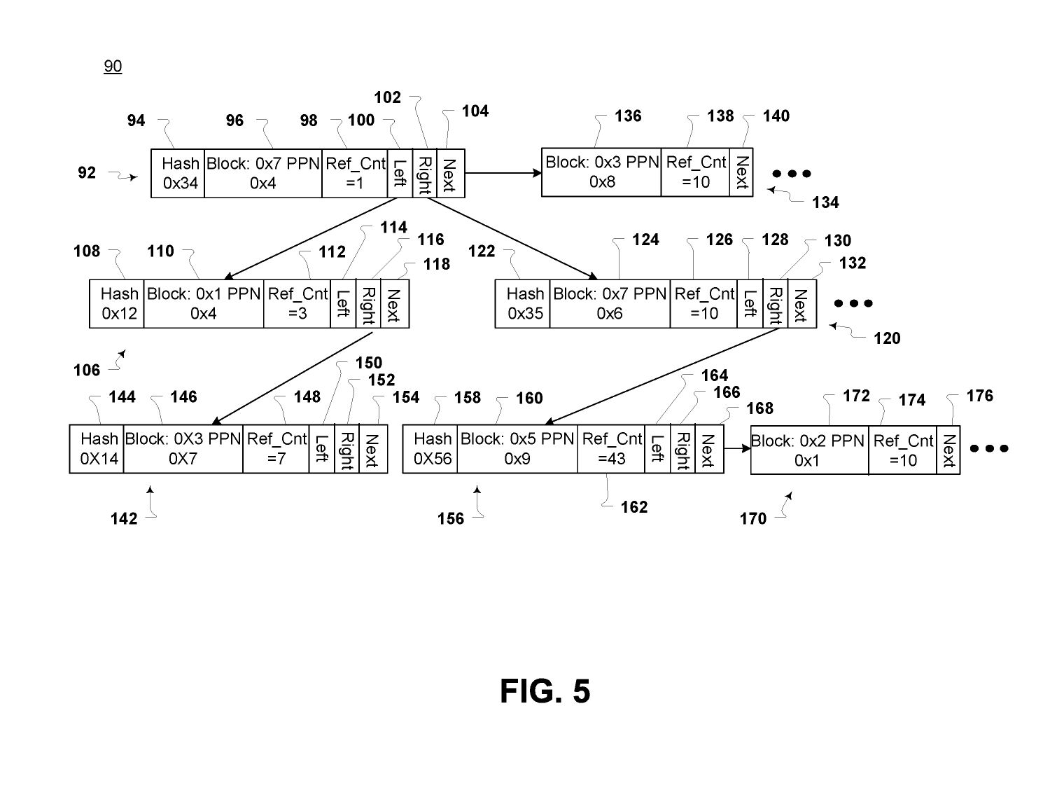

Referring now to FIG. 5, an exemplary partial binary hash tree structure 90 is depicted that can be included in a data pattern database. Each node of the tree includes a physical page number (PPN) a reference count, and pointers. Node 92 includes an identifier 94 (hash value 0x34), a physical storage address 96 (Block: 0x7 PPN 0x4) where a corresponding data pattern is located in storage, a reference count 98 (Ref_Cnt=1), a LEFT pointer 100 to the previous node in the tree, a RIGHT pointer 102 to the next node in the tree, and a NEXT pointer 104 to the next node in the linked list, or collision list, corresponding to identifier 94.

LEFT pointer 100 includes a physical storage address where node 106 is stored. Node 106 includes an identifier 108 (hash value 0x12), a physical storage address 110 (Block: 0x1 PPN 0x4) where a corresponding data pattern is located in storage, a reference count 112 (Ref_Cnt=3), a LEFT pointer 114 to the previous node in the tree, a RIGHT pointer 116 to the next node in the tree, and a NEXT pointer 118 to the next node in the linked list, or collision list, corresponding to identifier 108.

RIGHT pointer 102 includes a physical storage address where node 120 is stored. Node 120 includes an identifier 122 (hash value 0x35), a physical storage address 124 (Block: 0x10 PPN 0x6) where a corresponding data pattern is located in storage, a reference count 124 (Ref_Cnt=10), a LEFT pointer 128 to the previous node in the tree, a RIGHT pointer 130 to the next node in the tree, and a NEXT pointer 132 to the next node in the linked list, or collision list, corresponding to identifier 122.

NEXT pointer 104 includes a physical storage address where node 134 is stored. Node 134 includes a physical storage address 136 (Block: 0x3 PPN 0x8) where a corresponding data pattern is located in storage, a reference count 138 (Ref_Cnt=10), and a NEXT pointer 140 to the next node in the linked list, or collision list, corresponding to identifier 94.

RIGHT pointer 116 includes a physical storage address where node 142 is stored. Node 142 includes an identifier 144 (hash value 0x14), a physical storage address 146 (Block: 0x3 PPN 0x7) where a corresponding data pattern is located in storage, a reference count 148 (Ref_Cnt=7), a LEFT pointer 150 to the previous node in the tree, a RIGHT pointer 152 to the next node in the tree, and a NEXT pointer 154 to the next node in the linked list, or collision list, corresponding to identifier 144.

RIGHT pointer 130 includes a physical storage address where node 156 is stored. Node 156 includes an identifier 158 (hash value 0x56), a physical storage address 160 (Block: 0x5 PPN 0x9) where a corresponding data pattern is located in storage, a reference count 162 (Ref_Cnt=43, a LEFT pointer 164 to the previous node in the tree, a RIGHT pointer 166 to the next node in the tree, and a NEXT pointer 168 to the next node in the linked list, or collision list, corresponding to identifier 158.

NEXT pointer 168 includes a physical storage address where node 170 is stored. Node 170 includes a physical storage address 172 (Block: 0x2 PPN 0x1) where a corresponding data pattern is located in storage, a reference count 174 (Ref_Cnt=10, and a NEXT pointer 176 to the next node in the linked list, or collision list, corresponding to identifier 158.

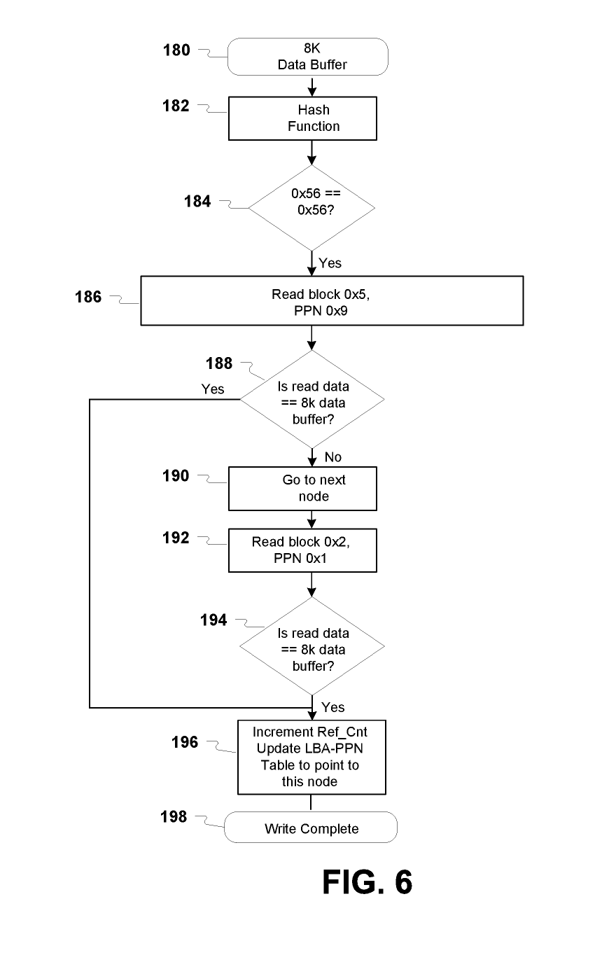

Referring now to FIG. 6, another exemplary process flow is illustrated that may be performed, for example, by the deduplication device 10 of FIG. 1 to implement an embodiment of the in-storage deduplication process described in this disclosure with reference to the binary hash tree structure 90 of FIG. 4. The process begins at block 180, where an 8 KB data buffer holds write data for deduplication.

In block 182, a hash function calculates the hash value (0x56) based on the write data. The same hash value is found in an existing entry in the hash tree, in block 184. (Refer to node 156 of FIG. 5.) The corresponding data pattern is read from storage (Block 0x5, PPN 0x9) in block 186. The read data pattern is compared with the write data in the buffer, in block 188. If the read data pattern does not match the write data in the buffer, the process moves on in block 190 to the next node in the linked list corresponding to the hash value.

In block 192, the data pattern corresponding to the next node 170 in the linked list is read from storage (Block 0x2, PPN 0x1). The read data pattern is compared with the write data in the buffer, in block 194. If the read data pattern matches the write data in the buffer, the corresponding reference count 174 is incremented and the mapping table is modified to point to node 170 with respect to the write data, in block 196. In block 198, the write operation is complete.

Aspects of this disclosure are described herein with reference to flowchart illustrations or block diagrams, in which each block or any combination of blocks can be implemented by computer program instructions. The instructions may be provided to a processor of a general purpose computer, special purpose computer, or other programmable data processing apparatus to effectuate a machine or article of manufacture, and when executed by the processor the instructions create means for implementing the functions, acts or events specified in each block or combination of blocks in the diagrams.

In this regard, each block in the flowchart or block diagrams may correspond to a module, segment, or portion of code that including one or more executable instructions for implementing the specified logical function(s). It should also be noted that, in some alternative implementations, the functionality associated with any block may occur out of the order noted in the figures. For example, two blocks shown in succession may, in fact, be executed substantially concurrently, or blocks may sometimes be executed in reverse order.

A person of ordinary skill in the art will appreciate that aspects of this disclosure may be embodied as a device, system, method or computer program product. Accordingly, aspects of this disclosure, generally referred to herein as circuits, modules, components or systems, or the like, may be embodied in hardware, in software (including firmware, resident software, micro-code, etc.), or in any combination of software and hardware, including computer program products embodied in a computer-readable medium having computer-readable program code embodied thereon.

It will be understood that various modifications may be made. For example, useful results still could be achieved if steps of the disclosed techniques were performed in a different order, and/or if components in the disclosed systems were combined in a different manner and/or replaced or supplemented by other components. Accordingly, other implementations are within the scope of the following claims.

What is claimed is:

1. A storage device for reducing duplicated data, comprising:
a memory that stores machine instructions; and
a controller coupled to the memory that executes the machine instructions to compare a data pattern associated with a write request to stored data, increment a counter associated with the data pattern based on the data pattern matching the stored data, and map a source storage address corresponding to the data pattern to a physical storage address associated with the storage device.

2. The storage device of claim 1, further comprising a nonvolatile storage medium, wherein the stored data is stored at the physical storage address in the nonvolatile storage medium and the data pattern corresponds to a page size associated with the nonvolatile storage medium.

3. The storage device of claim 2, wherein the nonvolatile storage medium comprises NAND flash memory and the controller further executes the machine instructions to compare the data pattern to a page of stored data.

4. The storage device of claim 3, wherein the controller further executes the machine instructions to store the data pattern in a page of NAND flash memory at the physical storage address in the nonvolatile storage medium based on the data pattern not matching the stored data, and create an entry in a data pattern database including a reference to the physical storage address and a reference counter.

5. The storage device of claim 1, further comprising a nonvolatile storage medium, wherein the stored data is stored at the physical storage address in the nonvolatile storage medium and the data pattern corresponds to a block size associated with the nonvolatile storage medium.

6. The storage device of claim 5, wherein the nonvolatile storage medium comprises NAND flash memory and the controller further executes the machine instructions to compare the data pattern to a block of stored data.

7. The storage device of claim 6, wherein the controller further executes the machine instructions to store the data pattern in a block of NAND flash memory at the physical storage address in the nonvolatile storage medium based on the data pattern not matching the stored data, and create an entry in a data pattern database including a reference to the physical storage address and a reference counter.

8. The storage device of claim 1, wherein the controller further executes the machine instructions to update a mapping table associated with a flash translation layer of the storage device to map the source storage address to the physical storage address.

9. A method for reducing duplicated data in a storage, comprising:
delimiting a segment of data comprising a data pattern;
determining whether the data pattern is included in the storage;
incrementing a counter associated with the data pattern based on the data pattern being included in the storage; and
updating a mapping table associated with a flash translation layer of the storage to associate a source storage address corresponding to the segment with a physical storage address corresponding to a storage unit of the storage that includes the data pattern.

10. The method of claim 9, wherein the storage includes flash memory and the segment corresponds to a page of flash memory.

11. The method of claim 10, further comprising storing the segment in a page of flash memory at the physical storage address based on the data pattern not being included in the storage, and creating an entry in a data pattern database including a reference to the physical storage address and a reference counter corresponding to the data pattern.

12. The method of claim 9, wherein the storage includes flash memory and the segment corresponds to a block of flash memory.

13. The method of claim 12, further comprising storing the segment in a block of flash memory at the physical storage address based on the data pattern not being included in the storage, and creating an entry in a data pattern database including a reference to the physical storage address and a reference counter corresponding to the data pattern.

14. The method of claim 9, wherein the source storage address corresponds to a logical block address.

15. A computer program product for reducing duplicated data in a storage, comprising:
a non-transitory, computer-readable storage medium encoded with instructions adapted to be executed by a processor to implement:
delimiting a segment of data comprising a data pattern;
determining whether the data pattern is included in the storage;
incrementing a counter associated with the data pattern based on the data pattern being included in the storage; and
updating a mapping table associated with a flash translation layer of the storage to associate a source storage address corresponding to the segment with a physical storage address corresponding to a storage unit of the storage that includes the data pattern.

16. The method of claim 15, wherein the storage includes flash memory and the segment corresponds to a page of flash memory.

17. The method of claim 16, wherein the instructions are further adapted to implement storing the segment in a page of flash memory at the physical storage address based on the data pattern not being included in the storage, and creating an entry in a data pattern database including a reference to the physical storage address and a reference counter corresponding to the data pattern.

18. The method of claim 15, wherein the storage includes flash memory and the segment corresponds to a block of flash memory.

19. The method of claim 18, wherein the instructions are further adapted to implement storing the segment in a block of flash memory at the physical storage address based on the data pattern not being included in the storage, and creating an entry in a data pattern database including a reference to the physical storage address and a reference counter corresponding to the data pattern.

20. The method of claim 15, wherein the source storage address corresponds to a logical block address.
